(19) United States
(12) Patent Application Publication
(10) Pub. No.: US 2007/0019604 A1
(43) Pub. Date: Jan. 25, 2007

(54) Method for controlling media access in wireless sensor network

(75) Inventors: Kyeong Hur, Seoul (KR); Chung-gu Kang, Seoul (KR); Ii-whan Kim, Incheon (KR); Ki-seok Chang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/412,829

(22) Filed: Apr. 28, 2006

(30) Foreign Application Priority Data
May 31, 2005 (KR) 2005-0046460

(51) Int. Cl. H04B 7/212

(52) U.S. Cl. 370/347; 370/349

(57) ABSTRACT

A media access control method of a wireless sensor network (WSN) is provided. The media access control method includes first sensor nodes, existing in a non-overlapping area where clusters do not overlap, media-accessing with a Time Division Multiple Access (TDMA) method and communicating with a Cluster head (CH) in a first section. Further, and the method includes second sensor nodes, existing in an overlapping area where the clusters overlap, media-accessing with a contention-based method and communicating with the CH in a second section. Because communication between nodes of the non-overlapping area where the clusters do not overlap, uses a reservation-based TDMA method, collision between nodes can be prevented, and because communication between nodes of the overlapping area where the clusters overlap, uses a contention-based CSMA/CA method, interference between neighboring clusters can be prevented.

### CROSS-REFERENCE TO RELATED APPLICATION

This application claims priority from Korean Patent Application No. 2005-46460, filed May 31, 2005, in the Korean Intellectual Property Office, the entire contents of which are incorporated herein by reference.

### BACKGROUND OF THE INVENTION

1. Field of the Invention

Methods consistent with the present invention relate to controlling media access for preventing collision of transmission signals between nodes of a wireless sensor network and interferences between clusters by using a single frequency channel.

2. Description of the Related Art

A cluster-based hierarchy routing has far more advantages than a plane-structure routing in a wireless sensor network (WSN).

The cluster-based hierarchy routing divides a wireless sensor network into a plurality of regions of cluster units, and divides the nodes of the cluster into cluster head, gateway and sensor nodes according to the respective roles. Because routing is possible only with cluster head and gateway nodes, and a plurality of sensor nodes can be omitted, a wireless sensor network with high energy efficiency can be constructed.

In the cluster-based hierarchy structure, there are mainly contention-based Carrier Sensor Multiple Access/Collision Avoidance (CSMA/CA) and reservation-based Time Division Multiple Access (TDMA) methods used for communicating between the sensor nodes and the cluster head to avoid “intracluster collision”, which is the collision between sensor nodes of the same cluster.

The contention-based CSMA/CA transmits data without intracluster collision by using a Request to Send/Clear to Send (RTS/CTS) signal between the cluster head and the sensor nodes of the cluster. However, as the number of sensor nodes increases, collisions between nodes rapidly increase, requiring more frequent re-transmission of data. As much energy is consumed at the sensor nodes, this cannot be appropriate for a sensor network.

The reservation-based TDMA method transmits data without having intracluster collision by reserving sensor nodes of the cluster for each region. However, TDMA is basically accompanied with intercluster interference, which is the interference between neighboring clusters, in a multi-cluster environment. That is, when the sensor nodes in the overlapping area of the neighboring clusters transfer data, the sensor nodes cause interferences to the other sensor nodes of the neighboring cluster which are also sending out the data.

In order to overcome the intercluster interferences, in the related art, different frequencies or spread codes have been used, or a communication period was time-divided for each of the clusters.

### SUMMARY OF THE INVENTION

The present invention has been made to overcome the problems of the related art, and accordingly, it is an object of the present invention to provide a media access control method which is capable of minimizing collisions between sensor nodes of the same cluster and preventing interferences between neighboring clusters, without using different frequency channels or spread codes for each cluster or a time-dividing communication period, but using a single frequency channel.

The above aspects of the present invention can be achieved by providing a media access control method of a wireless sensor network (WSN), in which sensor nodes, existing in a non-overlapping area where clusters do not overlap, media-access with a Time Division Multiple Access (TDMA) method and communicate with a Cluster head (CH) in a first section, and other sensor nodes, existing in an overlapping area where the clusters overlap, media-access with a contention-based method and communicate with the CH in a second section.

In the communicating operation in the second section, the CH, gateway (GW) and the sensor nodes existing in the overlapping area may media-access with the contention-based method and communicate with one of the CH and the GW.

Further, the CH may transfer a beacon and a query to a GW, the sensor nodes existing in the non-overlapping area, and the sensor nodes existing in the overlapping area in a third section, and the GW transfers the beacon and the query received from the CH to a neighboring CH in a fourth section. The neighboring CH is the CH of a neighboring cluster.

The first to fourth sections may be arranged in a frame in the order of the third section, the first section, the fourth section and the second section.

Also, the sensor nodes existing in the non-overlapping area may be in a sleep state in the second and the fourth sections.

Additionally, the sensor nodes existing in the non-overlapping area may be in a sleep state in the first section when there is no data to send to the CH.

The sensor nodes existing in the overlapping area may be in a sleep state in the first and the fourth sections.

The sensor nodes existing in the overlapping area may be in a sleep state in the second section when there is no data to send to the CH.

Also, the GW may be in a sleep state in the first section.

The GW may be in a sleep state in the second section when there is no data to send to the CH in the second section.

The CH media-accesses may be in an allocated slot of the third section and transfer the beacon and the query.

The GW media-accesses may be in an allocated slot of the fourth section and transfer the beacon and the query.

Finally, but nit limited thereto, the sensor nodes existing in the non-overlapping area may media-access in respectively allocated slots of the first section and communicate with the CH.

### BRIEF DESCRIPTION OF THE DRAWINGS

The above aspects of the present invention will become more apparent by describing in detail exemplary embodiments thereof with reference to the attached drawings, in which:

FIG. 1 is a view illustrating nodes of a wireless sensor network (WSN) applicable with a media access control method according to an exemplary embodiment of the present invention;

FIG. 2 is a view illustrating a frame structure for use in a media access control method according to an exemplary embodiment of the present invention;

FIG. 3 is a view illustrating the node of the WSN media-accessing and communicating using the frame of FIG. 2;

FIG. 4 is a view illustrating transfer of a beacon and query in a WSN with a media access control method according to an exemplary embodiment of the present invention;

FIG. 5A is a view illustrating GW and a CSMA/CA node (CN) of a Beacon Transmission Period (BTP) failing to receive a beacon and query;

FIG. 5B is a view illustrating CH of a Beacon Relay Period (BRP) failing to receive a beacon and query;

FIGS. 6A and 6B are views provided for additionally explaining a media access through allocation of a BTP slot and a BRP slot;

FIG. 7 is a view illustrating the data transfer process in a WSN with a media access method according to an exemplary embodiment of the present invention;

FIG. 8 is a view provided for explaining the method of CH to allocate TDMA nodes (TNs) with TDMA slots; and

FIG. 9 is a view illustrating TN, GW and CN in an active/sleep state.

### DETAILED DESCRIPTION OF EXEMPLARY EMBODIMENTS OF THE INVENTION

Hereinafter, the present invention will be described in detail with reference to the drawings.

FIG. 1 is a view illustrating nodes of a WSN applicable with a media access control method according to an exemplary embodiment of the present invention. As shown in FIG. 1, nodes of the WSN can be divided according to respective roles into: cluster head (CH), gateway (GW), TDMA node (TN) and CSMA/CA node (CN).

A CH manages the cluster, and thus, transmits a beacon and query to a GW, TN and CN of its own cluster, aggregates the data received from the GW, TN and CN, and transfers the aggregated data to the GW from which the CH received the beacon and query. CH also manages resources of a TDMA sub-frame which will be described below, and in this aspect of the invention, the CH may also operate as a coordinator.

A GW is the node selected by certain algorithms among the nodes which are set to single-hop connect with two or more CHs. The GW transfers a beacon and query received from a CH to the neighboring CH, and transfers the data received from the neighboring CH to the CH from which the GW received the beacon and query. The “neighboring CH” refers to a CH of the neighboring cluster.

A TN is the sensor node which transmits data about events occurring in a corresponding area to the CH from which a TN received a beacon and query. The TN is set to single-hop connect to one CH. Accordingly, the TN exists in the area where the clusters are not overlapped (hereinbelow called “non-overlapping area”). The TN media-accesses with the TDMA method and communicates with the CH.

A CN is similar with a TN in a sense that the CN is the sensor node which transfers the data regarding events occurring in a corresponding area to the CH from which the CN received a beacon and query. The difference is that the CN is set to single-hop connect to two or more CHs. That is, the CN exists in the area where the clusters are overlapped (hereinbelow called “overlapping area”). The CN media-accesses and communicates with a CH with the CSMA/CA (Carrier Sensor Multiple Access/Collision Avoidance) method.

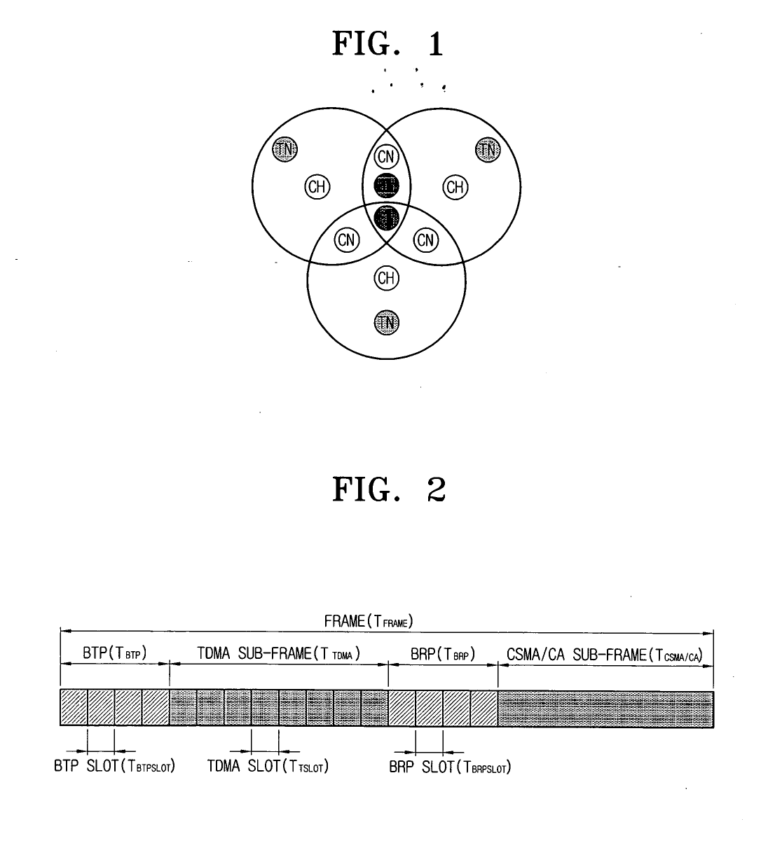

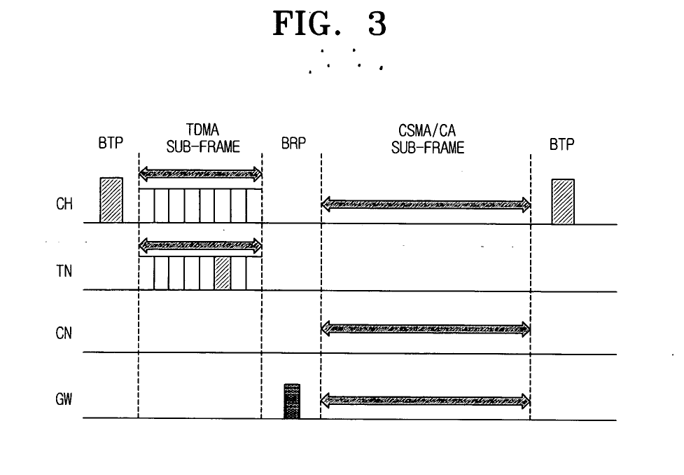

FIG. 2 shows the frame structure which is used in a media access control method according to an exemplary embodiment of the present invention. According to this embodiment, the frame includes a BTP (Beacon Transmission Period), a TDMA sub-frame, a BRP (Beacon Relay Period) and a CSMA/CA sub-frame. As shown in FIG. 2, the lengths of the BTP, TDMA sub-frame, BRP and CSMA/CA sub-frame are, respectively, T_{BTP}, T_{TDMA}, T_{BRP} and T_{CSMA/CA}.

FIG. 3 is a view illustrating the node of the WSN media-accessing and communicating using the frame of FIG. 2. As shown in FIG. 3, a CH transfers a beacon and query to a GW, TN and CN of the same cluster in BTP. In other words, BTP is used for downward link data transmission of a CH. In BTP, the CH notifies each TN of TDMA slot information. The TDMA slot information is information about TDMA slots which are allocated to the respective TN in the TDMA sub-frame. For an efficient transfer, the TDMA slot information may be transferred together with a beacon and query.

In TDMA sub-frame, TN transfers data to the CH from which it received a beacon and query. More specifically, TN accesses the media in the TDMA slot which is allocated in the TDMA sub-frame and transfers data. That is, TDMA sub-frame is used for upward link data transmission of TN.

In BRP, GW transfers a beacon and query received from CH in BTP to the neighboring CH. In other words, BRP is used for downward link data transmission of GW.

In CSMA/CA sub-frame, the CH, GW and CN access the media through competition, and transfer data. More specifically, the GW and CN transfer data to a CH from which they received a beacon, and the CH aggregates the data received from the GW and CN and transfers the data to the GW from which it received the beacon and query. In other words, CSMA/CA sub-frame is used for upward link data transmission of the CH, GW and CN.

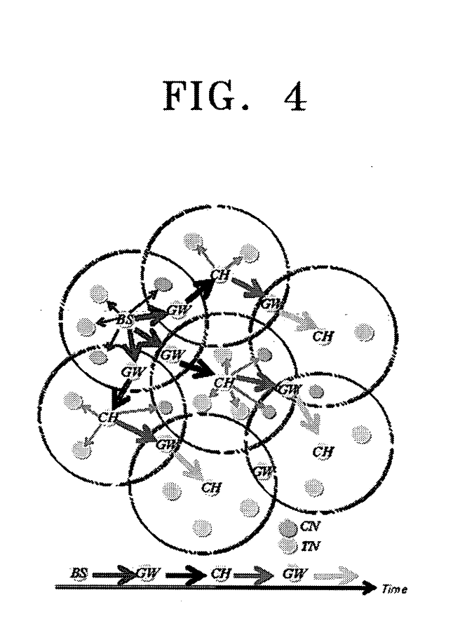

Transmission of a beacon and query in WSN will be explained in greater detail below with reference to FIG. 4. FIG. 4 is a view illustrating transfer of a beacon and query in a WSN with a media access control method according to an exemplary embodiment of the present invention.

A beacon and query are transferred in BTP and BRP. More specifically, the beacon and query are transferred by a CH or base station (BS) in BTP, and transferred by GW in BRP. BS is the node which is connected with a backbone network through a wire, and manages the WSN.

More specifically, a BS transfers the beacon and query to a GW, TN and CN of the same cluster in the BTP of the first frame. The GW, receiving the beacon and query from the BS, transfers the received beacon and query to the neighboring CH in the BRP of the first frame.

Next, a CH, receiving the beacon and query from the GW, transfers the received beacon and query to the GW, TN and CN of the same cluster in the BTP of the second frame. The GW, receiving the beacon and query from the CH, transfers the received beacon and query to the neighboring CH in the BRP of the second frame.

As the above processes repeat, the beacon and query generated at BS can be transferred to all of the nodes of the WSN as shown in FIG. 4.

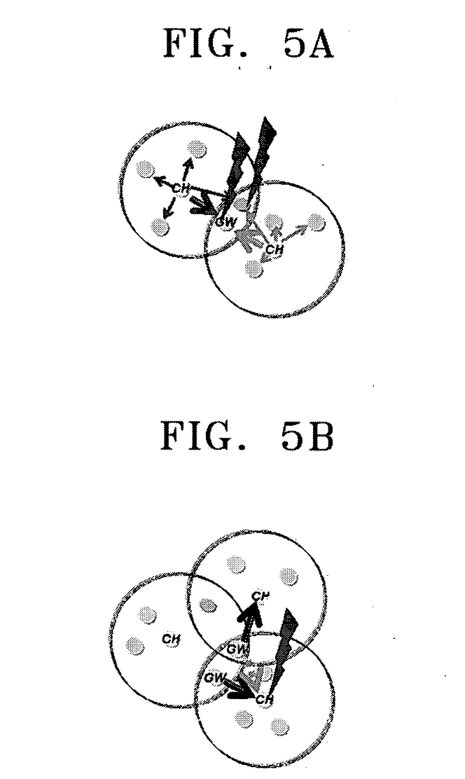

Meanwhile, certain nodes may not be able to receive a beacon and query in BTP or BRP. As shown in FIG. 5A, for example, several CHs simultaneously transfer a beacon and query to a GW and CN of the overlapping area in BTP, resulting in collision. In this case, the GW and CN do not receive the beacon and query. Also as shown in FIG. 5B, several GWs transfer the bacon and query to a CH in BRP, again causing collision. In this case also, the CH fails to receive beacon and query.

In order to prevent the above collisions, in another exemplary embodiment of the present invention, the BTP and BRP are divided into a plurality of slots (FIG. 2). More specifically, one BTP slot is allocated to each of the CHs transferring a beacon and query in BTP, and respectively different BTP slots are allocated. Likewise, one BRP slot is allocated to each of the GWs transferring a beacon and query in BRP, and respectively different BRP slots are allocated.

Slot allocation may preferably be performed in the clustering process. As the neighboring CHs do not transfer a beacon and query at the same time, or neighboring GWs do not transfer a beacon and query at the same time, the above-mentioned problems can be prevented.

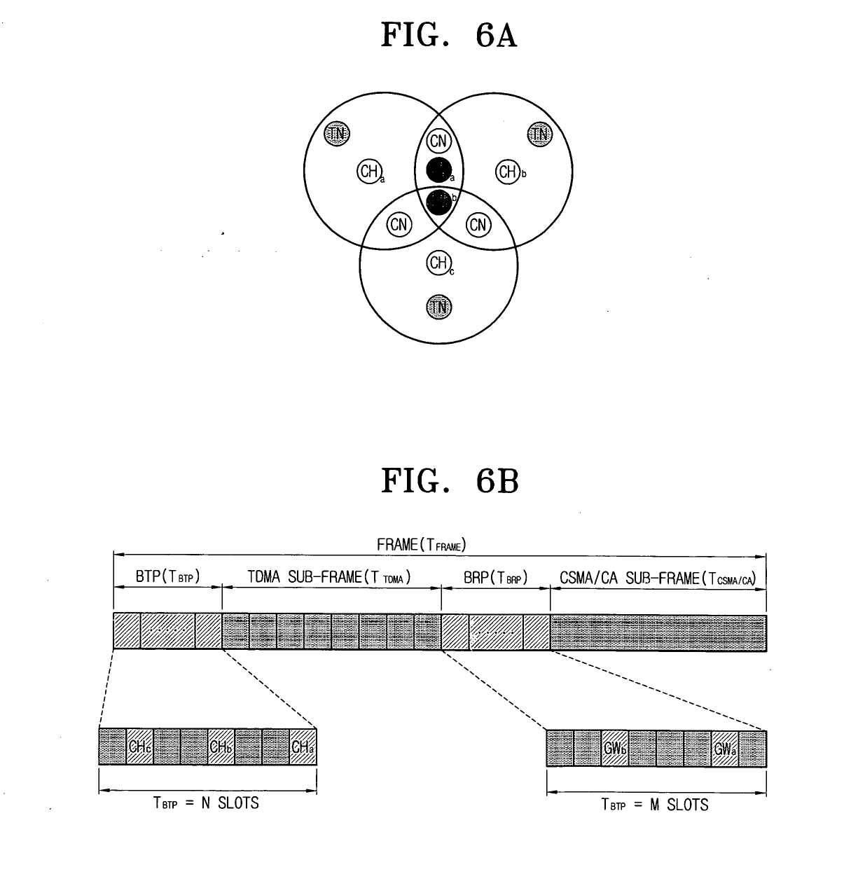

FIG. 6A shows the nodes of a WSN, and FIG. 6B shows each of CHs (CHa, CHb, CHc) allocated with one BTP slot, and each of GWs (GWa, GWb) allocated with one BRP slot. With the media access according to the frame of FIG. 6B, there will be no node in FIG. 6A which fails to receive a beacon and query.

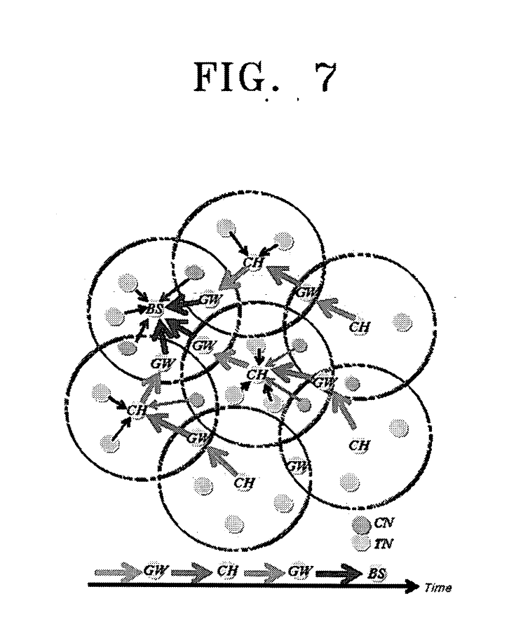

The process of data transfer in a WSN will now be explained with reference to FIG. 7. FIG. 7 is a view illustrating the data transfer process in a WSN with a media access method according to an exemplary embodiment of the present invention.

Data is transferred in TDMA sub-frame and CSMA/CA sub-frame. More specifically, a TN accesses the media in the allocated TDMA slot of the TDMA sub-frame, and transfers data to a CH from which it received beacon and query.

A CH, GW and CN access the media through competition and transfer data in the CSMA/CA sub-frame. More specifically, the GW and CN transfer data to a CH from which they received beacon, and the CH aggregates the received data from the GW and CN and transfers the aggregated data to the GW from which it received beacon and query.

As shown in FIG. 7, the data transfer route is opposite to the transfer route of the beacon and query shown in FIG. 4.

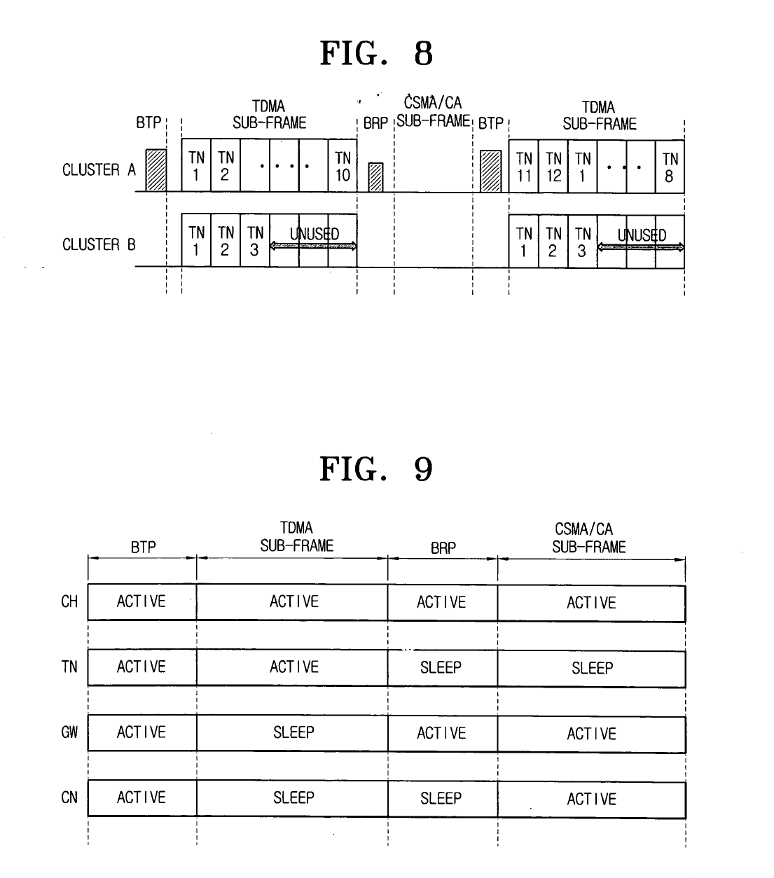

The method of a CH to allocate TNs of the same cluster with TDMA slots will now be explained with reference to FIG. 8. FIG. 8 is a view provided for explaining the method of a CH to allocate TNs with TDMA slots.

For the convenience of explanation, it will now be assumed that TDMA sub-frame is composed of 10 TDMA slots, cluster A has 12 TNs (TN1 to TN12), and cluster B has 3 TNs (TN1 to TN3).

The cluster A has more TNs (that is, 12 TNs) than the number of TDMA slots (that is, 10 slots). In this case, CH allocates 10 TNs (TN1 to TN10) with the TDMA slots of the first TDMA sub-frame, and then allocates the rest of the TNs (TN11 and TN12) with the TDMA slots of the second TDMA sub-frame.

The cluster B has less TNs (that is, 3 TNs) than the number of TDMA slots (that is, 10 slots). In this case, CH allocates the three TNs (TN1 to TN3) with TDMA slots of the TDMA sub-frame, and does not use the remaining TDMA slots.

TDMA slots may be allocated to TNs by CH in the order of lower IDs.

Media access control methods according to exemplary embodiments of the present invention have been described above. With the media access control methods of these embodiments, more sleep time can be guaranteed to the GW, TN and CN of the WSN, and therefore, energy efficiency of the WSN increases. This will be explained in detail below with reference to FIG. 9. FIG. 9 shows a CH, TN, GW and CN in an active/sleep state.

A TN receives a beacon and query in BTP, and transfers data in the allocated TDMA slot of TDMA sub-frame. Accordingly, the TN is in an active state during the BTP and the allocated TDMA slot of the TDMA sub-frame. The TN is in a sleep state in the BRP, CSMA/CA sub-frame and TDMA slots excluding the allocated TDMA slots of TDMA sub-frame. The TN may turn to a sleep state in the entire TDMA sub-frame when there is no data to send and therefore, power consumption is reduced.

A CN receives a beacon and query in BTP, and transfers data in CSMA/CA sub-frame. Accordingly, the CN is in an active state in the BTP and certain parts (that is, a starting point of CSMA/CA sub-frame until finishing point of data transfer) during CSMA/CA sub-frame. The CN is in a sleep state in the BRP, TDMA sub-frame and the rest parts of the CSMA/CA sub-frame. The CN may turn to a sleep state in the entire CSMA/CA sub-frame when there is no data to send and therefore, power consumption is reduced.

A GW receives a beacon and query in BTP, transfers the beacon and query in BRP, and transfers data in a CSMA/CA sub-frame. Accordingly, the GW is in an active state in BTP, BRP and certain parts of the CSMA/CA sub-frame (that is, from a starting point of the CSMA/CA sub-frame until a finishing point of data transfer). The GW is in a sleep state in the TDMA sub-frame and the rest parts of the CSMA/CA sub-frame. The GW may turn to a sleep state in the entire CSMA/CA sub-frame when there is no data to send and therefore, power consumption is reduced.

As described above, communication between nodes of the non-overlapping area where the clusters do not overlap, uses a reservation-based TDMA method. Therefore, collision between nodes can be prevented. Then communication between nodes of the overlapping area where the clusters overlap, uses a contention-based CSMA/CA method. Therefore, interference between neighboring clusters can be prevented.

With the media access control method according to the present invention, sensor nodes can be selectively turned to a sleep state in the TDMA sub-frame and the CSMA/CA sub-frame. Therefore, energy efficiency may be increased in the wireless sensor network.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A media access control method of a wireless sensor network (WSN), the media access control method comprising:
first sensor nodes, existing in a non-overlapping area where clusters do not overlap, media-accessing with a Time Division Multiple Access (TDMA) method and communicating with a Cluster head (CH) in a first section; and
second sensor nodes, existing in an overlapping area where the clusters overlap, media-accessing with a contention-based method and communicating with the CH in a second section.

2. The media access control method of claim 1, wherein in the communicating operation in the second section, the CH, a gateway (GW) and the second sensor nodes existing in the overlapping area media-access with the contention-based method and communicate using at least one of the CH and the GW.

3. The media access control method of claim 1, further comprising:
the CH, transferring a beacon and a query to a gateway (GW), the first sensor nodes existing in the non-overlapping area, and the second sensor nodes existing in the overlapping area in a third section; and
the GW, transferring the beacon and the query received from the CH to a neighboring CH in a fourth section, the neighboring CH being a CH of a neighboring cluster.

4. The media-access control method of claim 3, wherein the first to fourth sections are arranged in a frame in the order of the third section, the first section, the fourth section and the second section.

5. The media-access control method of claim 3, further comprising placing the sensor nodes existing in the non-overlapping area in a sleep state in the second and the fourth sections.

6. The media-access control method of claim 5, further comprising placing the sensor nodes existing in the non-overlapping area in a sleep state in the first section when there is no data to send to the CH.

7. The media-access control method of claim 3, further comprising placing the sensor nodes existing in the overlapping area in a sleep state in the first and the fourth sections.

8. The media-access control method of claim 7, further comprising placing the sensor nodes existing in the overlapping area in a sleep state in the second section when there is no data to send to the CH.

9. The media-access control method of claim 3, further comprising placing the GW is in a sleep state in the first section.

10. The media-access control method of claim 9, further comprising placing the GW is in a sleep state in the second section when there is no data to send to the CH in the second section.

11. The media-access control method of claim 3, wherein the CH media-accesses in an allocated slot of the third section and transfers the beacon and the query.

12. The media-access control method of claim 3, wherein the GW media-accesses in an allocated slot of the fourth section and transfers the beacon and the query.

13. The media-access control method of claim 1, wherein the sensor nodes existing in the non-overlapping area media-access in respectively allocated slots of the first section and communicate with the CH.
